(19) United States
(12) Patent Application Publication
(10) Pub. No.: US 2013/0245173 A1
(43) Pub. Date: Sep. 19, 2013

(54) PROCESSING AID FOR THERMOPLASTIC POLYURETHANES

(71) Applicants: Thomas Welker, Hanau (DE); Ulrich Boes, Frankfurt a.M. (DE); Frank Menzel, Hanau (DE); Dieter Kuhn, Rodenbach (DE); Uwe Schachtely, Kahl am Main (DE); Didier Lagneaux, Frontonas (FR); Henri Sautel, Frontonas (FR)

(72) Inventors: Thomas Welker, Hanau (DE); Ulrich Boes, Frankfurt a.M. (DE); Frank Menzel, Hanau (DE); Dieter Kuhn, Rodenbach (DE); Uwe Schachtely, Kahl am Main (DE); Didier Lagneaux, Frontonas (FR); Henri Sautel, Frontonas (FR)

(73) Assignee: Evonik Degussa GmbH, Essen (DE)

(21) Appl. No.: 13/892,722

(22) Filed: May 13, 2013

Related U.S. Application Data
(62) Division of application No. 12/579,609, filed on Oct. 15, 2009.
(60) Provisional application No. 61/106,737, filed on Oct. 20, 2008.

(30) Foreign Application Priority Data
Oct. 15, 2008 (EP) 08166704.0

(51) Int. Cl. C08K 5/5419

(52) U.S. Cl. CPC C08K 5/5419
USPC 524/263

(57) ABSTRACT

A processing aid is used in the processing of thermoplastic polyurethanes to give various articles including a self-supporting film. The processing aid contains a) 10-50% by weight of hydrophobized, at least partially aggregated, metal oxide particles selected from the group consisting of aluminium oxide, silicon dioxide and mixtures thereof, b) 20-75% by weight of one or more thermoplastic polyurethanes, c) 0.5-25% by weight of one or more isocyanates, d) 0.5-15% by weight of one or more compounds which act as lubricant and dispersant, the sum of the constituents a) to d) amounting to at least 90% by weight, based on a total weight of said processing aid.

### BACKGROUND OF THE INVENTION

1. Field of the Invention

The invention relates to a processing aid, which can be used when processing thermoplastic polyurethanes, and to its preparation and use. The invention furthermore relates to a process for the preparation of self-supporting films with the assistance of the processing aid.

2. Description of the Background Art

Thermoplastic polyurethanes (TPU) are manufactured in large amounts and in a wide range of grades. This group of substances is in this connection, because of its good elastic properties, in combination with the possibility of thermoplastic moulding, its chemical resistance and its abrasion resistance particularly attractive. They are accordingly suitable, for example, for mechanically and thermally stressed coatings, hoses, pipes, profiles, wearing parts and other moulded articles.

Thermoplastic polyurethanes are formed from linear polyols, generally polyester or polyether polyols, organic diisocyanates and short-chain diols (chain extenders). Use may additionally be made of catalysts for accelerating the formation reaction. They are partially crystalline materials and belong to the class of thermoplastic elastomers. They are characterized by the segmented structure of the macromolecules into a crystalline (hard) region and into an amorphous (soft) region, which determines the properties of a thermoplastic polyurethane.

The hard and soft structural regions, which melt at very different temperatures and form a physical network at ambient temperature, and undesirable rheological properties of the TPU melt result in a complicated processing technique for the polyurethanes accompanied by an irreversible chain decomposition during the thermoplastic processing.

In order to overcome these disadvantages, it is proposed in the state of the art to introduce crosslinking into the thermoplastic polyurethane. As disclosed in WO 2005/054322, the formation of crosslinkages through addition of isocyanates to the molten thermoplastic polyurethane is known as prepolymer crosslinking. However, because of the complicated equipment, this process was unable hitherto to gain acceptance in practice. As explained further in WO 2005/054322, this concerns, inter alia, the difficulties in mixing the TPU, usually present as granules, as homogeneously as possible with the liquid or viscous compounds in which isocyanate groups are present.

In addition, the reaction of the thermoplastic polyurethane with the compounds in which isocyanate groups are present represents a difficult chemical problem since the mixing of the molten TPU with the prepolymer is usually carried out in an extruder, which can clog up if crosslinking is too fast or too dense.

The proposal is made, in WO2005/054322, to overcome these difficulties in the reaction of thermoplastic polyurethanes with compounds in which isocyanate groups are present by a process in which use is made of aliphatic isocyanates with at least three isocyanate groups and aromatic isocyanates with two isocyanate groups. This is supposed to make possible reliable process control. It is disadvantageous to the process that the handling problems and metering problems still continue to exist and the combination of difunctional and trifunctional isocyanates can be used for special thermoplastic polyurethanes but not universally.

The addition of diisocyanates to a thermoplastic polyurethane during the thermoplastic processing is not novel. It is explained, in DE-A-4115508, that this results in an improvement in the TPU properties.

DE-A 4112329 discloses a process in which the metering problems of the isocyanate added are supposed to be reduced by subjecting the starting TPU to swelling with a polyisocyanate which is liquid under the processing conditions.

WO 2006/128793 discloses a process in which a silicon dioxide obtained by a sol/gel process, a polyol and an isocyanate are reacted with formation of a thermoplastic polyurethane, the silicon dioxide being premixed with at least one of the starting materials. This should increase the flexibility of the polyurethane.

It is disadvantageous to the known process that it only partially solves the complex processing problems. Mention may be made here of the handling problems with isocyanates, metering problems, rheological problems during the processing, insufficient strength and insufficient tensile deformation and compressive set of the products.

### SUMMARY OF THE INVENTION

It was an object of the present invention to provide a processing aid with which it is possible to influence the properties of existing TPUs in the thermoplastic moulding in such a way that these disadvantages no longer occur. It was furthermore an object of the invention to provide a process for the preparation of this composition.

This and other objects have been achieved by the present invention, the first embodiment of which includes a processing aid, comprising:

a) 10-50% by weight of hydrophobized, at least partially aggregated, metal oxide particles selected from the group consisting of aluminium oxide, silicon dioxide and mixtures thereof,

b) 20-75% by weight of one or more thermoplastic polyurethanes,

c) 0.5-25% by weight of one or more isocyanates,

d) 0.5-15% by weight of one or more compounds which act as lubricant and dispersant, the sum of the constituents a) to d) amounting to at least 90% by weight, based on a total weight of said processing aid.

In another embodiment, the present invention relates to a process for the preparation of the above processing aid, said process comprising:

metering a mixture of a melt of the thermoplastic polyurethane, the hydrophobized metal oxide particles, the isocyanate and the lubricant and dispersant into an extruder or an injection-moulding device.

In yet another embodiment, the present invention relates to a process for obtaining a thermoplastic polyurethane article, comprising:

processing a thermoplastic polyurethane in the presence of the above processing aid.

The present invention also provides an article, obtained by processing of a thermoplastic polyurethane in the presence of the above processing aid.

Further, the present invention provides a process for the preparation of a self-supporting film, comprising:

metering a mixture of
a thermoplastic polyurethane, and
from 0.5 to 35 by weight, based on the thermoplastic polyurethane, of the above processing aid into an extruder,

melting and extruding the mixture via a film blowing die to give a film.

In addition, the present invention provides a self-supporting film, obtained by the above process.

### DETAILED DESCRIPTION OF THE INVENTION

A subject-matter of the invention is a processing aid comprising

a) 10-50% by weight of hydrophobized, at least partially aggregated, metal oxide particles chosen from the group consisting of aluminium oxide, silicon dioxide and mixtures of the abovementioned metal oxides,

b) 20-75% by weight of one or more thermoplastic polyurethanes,

c) 0.5-25% by weight of one or more isocyanates,

d) 0.5-15% by weight of one or more compounds which act as lubricant and dispersant,

the sum of the constituents a) to d) amounting to at least 90% by weight, preferably at least 95% by weight, based on the processing aid.

The components of the processing aid are in this connection distributed as homogeneously as possible.

In the present invention any ranges provided include all values and subvalues between the upper and lower limit of the range.

a) Hydrophobized Metal Oxide Particles

The hydrophobized metal oxide particles are, in the context of this invention, hydrophobized, at least partially aggregated, metal oxide particles chosen from the group consisting of aluminium oxide, silicon dioxide and mixtures of the abovementioned metal oxides. Silicon dioxide is in this connection to be regarded as a metal oxide. The term “mixtures” comprises physical mixtures and chemical mixtures, in which the metal oxide components are mixed at the molecular level.

The term “hydrophobized metal oxide particles” is to be understood as meaning those which are obtained by reaction of a surface-modifying agent with reactive groups, e.g. hydroxyl groups, present on the surface of nonhydrophobized metal oxide particles.

The term “aggregated” is to be understood as meaning that “primary particles”, produced first in the genesis of nonhydrophobized metal oxide particles, combine firmly together in the further course of the reaction with formation of a three-dimensional network. In contrast to agglomerates, these combinations can no longer be separated using conventional dispersing devices.

The description “at least partially aggregated” is to make it clear that the presence of aggregates is essential for the invention. The proportion of aggregates is preferably high in comparison with isolated individual particles, that is at least 80% of the hydrophobized metal oxide particles are to be present in the form of aggregates, or the particles of metal oxide are present completely in aggregated form. The aggregate to isolated individual particle ratio can, for example, be determined by quantitative evaluation of TEM photographs (TEM=Transmission Electron Microscopy).

The hydrophobic metal oxide particles are amorphous in the case of silicon dioxide particles, crystalline in the case of aluminum oxide particles. In the case of mixed oxide particles the particles may show amorphous or crystalline behaviour, depending on the prevailing metal oxide.

Silanes, individually or as a mixture, can be used, for example, as surface-modifying agent. Mention may be made, by way of example, of:

organosilanes (RO)₃Si(CₙH₂ₙ₊₁) and (RO)₃Si(CₘH₂ₘ₋₁) with R=alkyl, such as methyl, ethyl, n-propyl, isopropyl or butyl, n=1-20, m=2-20;

organosilanes (R¹)ₓ(RO)_{y}Si(CₙH₂ₙ₊₁) and (R¹)ₓ(RO)_{y}Si(CₘH₂ₘ₋₁) with R=alkyl, such as methyl, ethyl, n-propyl, isopropyl or butyl; R¹=alkyl, such as methyl, ethyl, n-propyl, isopropyl, butyl or cycloalkyl; n=1-20; m 0 2-20; x+y=3, x=1, 2; y=1, 2;

haloorganosilanes X₃Si(CₙH₂ₙ₊₁) and X₃Si(CₘH₂ₘ₋₁) with X=Cl, Br; n=1-20; m=2-20;

haloorganosilanes X₂(R)Si(CₙH₂ₙ₊₁) and X₂(R)Si(CₘH₂ₘ₋₁) with X=Cl, Br, R=alkyl, such as methyl, ethyl, n-propyl, isopropyl, butyl or cycloalkyl; n=1-20; m=2-20;

haloorganosilanes X(R)₂Si(CₙH₂ₙ₊₁) and X(R)₂Si(CₘH₂ₘ₋₁) with X=Cl, Br; R=alkyl, such as methyl, ethyl, n-propyl, isopropyl, butyl or cycloalkyl; n=1-20; m=2-20;

organosilanes (RO)₃Si(CH₂)ₘ—R¹ with R=alkyl, such as methyl, ethyl or propyl; m=0, 1-20; R¹=methyl, aryl, such as —C₆H₅, substituted phenyl radicals, C₄F₉, OCF₂—CHF—CF₃, C₆F₁₃, OCF₂CHF₂ or Sₓ—(CH₂)₃Si(OR)₃;

organosilanes (R₂)ₓ(RO)_{y}Si(CH₂)ₘ—R¹ with R¹=methyl, aryl, such as C₆H₅, substituted phenyl radicals, C₄F₉, OCF₂—CHF—CF₃, C₆F₁₃, OCF₂CHF₂, Sₓ—(CH₂)₃Si(OR)₃, SH, NR³R⁴R⁵, with R³=alkyl or aryl; R⁴=H, alkyl or aryl; and R⁵=H, alkyl, aryl or benzyl, or C₂H₄NR⁶R⁷, with R⁶=H or alkyl and R⁷=H or alkyl;

R²=alkyl; x+y=3; x=1, 2; y=1, 2; m=0, 1 to 20;

haloorganosilanes X₃Si(CH₂)ₘ—R with X=Cl, Br; R=methyl, aryl, such as C₆H₅, substituted phenyl radicals, C₄F₉, OCF₂—CHF—CF₃, C₆F₁₃, O—CF₂—CHF₂, Sₓ—(CH₂)₃Si(OR¹)₃, in which R¹=methyl, ethyl, propyl, butyl and x=1 or 2, or SH; m=0, 1-20;

haloorganosilanes R¹X₂Si(CH₂)ₘR² with X=Cl, Br; R¹=alkyl, such as methyl, ethyl or propyl; R²=methyl, aryl, such as C₆H₅, substituted phenyl radicals, C₄F₉, OCF₂—CHF—CF₃, C₆F₁₃, O—CF₂—CHF₂, —OOC(CH₃)C═CH₂, —Sₓ—(CH₂)₃Si(OR³)₃, in which R³=methyl, ethyl, propyl or butyl and x=1 or 2, or SH; m=0, 1-20;

haloorganosilanes (R¹)₂XSi(CH₂)ₘR² with X=Cl, Br; R¹=alkyl, such as methyl, ethyl or propyl; R²=methyl, aryl, such as C₆H₅, substituted phenyl radicals, C₄F₉, OCF₂—CHF—CF₃, C₆F₁₃, O—CF₂—CHF₂, —Sₓ—(CH₂)₃Si(OR³)₃, in which R³=methyl, ethyl, propyl or butyl and x=1 or 2, or SH; m=0, 1-20;

silazanes R²R¹₂SiNHSiR¹₂R² with R¹ and R²=alkyl, vinyl or aryl;

cyclic polysiloxanes D3, D4, D5 and their homologues, in which D3, D4 and D5 are to be understood as meaning cyclic polysiloxanes with 3, 4 or 5 units of the —O—Si(CH₃)₂ type, e.g. octamethylcyclotetrasiloxane=D4;

polysiloxanes or silicone oils of the type Y—O—[(R¹R²SiO)ₘ—(R³R⁴SiO)ₙ]ᵤ—Y, with R¹, R², R³ and R⁴ are, independently of one another, alkyl, such as CₙH₂ₙ₊₁, n=1-20; aryl, such as phenyl radicals and substituted phenyl radicals, (CH₂)ₙ—NH₂ or H;

Y=CH₃, H, CₙH₂ₙ₊₁, n=2-20; Si(CH₃)₃, Si(CH₃)₂H, Si(CH₃)₂OH, Si(CH₃)₂(OCH₃), Si(CH₃)₂(CₙH₂₊₁), n=2-20,

m=0, 1, 2, 3, . . . ∞, preferably 0, 1, 2, 3, . . . 100 000,

n=0, 1, 2, 3, . . . ∞, preferably 0, 1, 2, 3, . . . 100 000,

u=0, 1, 2, 3, . . . ∞, preferably 0, 1, 2, 3, . . . 100 000. Commercially available products are, for example, Rhodorsil® Oils 47 V 50, 47 V 100, 47 V 300, 47 V 350, 47 V 500 or 47 V 1000, Wacker Silicon Fluids AK 0.65, AK 10, AK 20, AK 35, AK 50, AK 100, AK 150, AK 200, AK 350, AK 500, AK 1000, AK 2000, AK 5000, AK 10000, AK 12500, AK 20000, AK 30000, AK 60000, AK 100000, AK 300000, AK 500000 or AK 1000000, or Dow Corning® 200 Fluid.

Use may preferably be made, as surface-modifying agents, of those which result in the hydrophobized metal oxide particles carrying, on their surface, the group

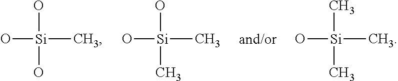

The detection of these groups can be carried out spectroscopically and is known to a person skilled in the art.

Those hydrophobized metal oxide particles prepared by means of pyrogenic processes are to be regarded as particularly suitable. These pyrogenic processes include flame hydrolysis and flame oxidation. In this connection, oxidizable and/or hydrolysable starting materials are generally oxidized or hydrolysed in a hydrogen/oxygen flame. Organic and inorganic materials can be used as starting materials for pyrogenic processes. Aluminium chloride and silicon tetrachloride are particularly suitable. The metal oxide particles thus obtained are to the greatest extent possible free from pores and exhibit free hydroxyl groups on the surface.

These are, as described further above, partially or completely reacted in a subsequent stage with a surface-modifying agent, resulting in the particles obtaining their hydrophobic properties. The degree of surface modification can be characterized by parameters such as methanol wettability or the density of OH groups. The determination of these parameters is known to a person skilled in the art.

In the context of the present invention, it has proven to be advantageous for the density of OH groups of the hydrophobized metal oxide particles to be equal to or less than 1.0 OH/nm² (determination according to J. Mathias and G. Wannemacher, Journal of Colloid and Interface Science, 125 (1988) by reaction with lithium aluminium hydride).

Hydrophobized aggregated silicon dioxide particles of pyrogenic origin as a powder or granules are very particularly suitable. Those powders commercially available as “R-Aerosil®” types (Evonik Degussa) are represented in Table 1 by way of example.

According to the invention, the proportion of hydrophobized metal oxide particles is from 10 to 50% by weight and preferably from 20 to 40% by weight, based on the processing aid.

TABLE 1
Hydrophobized silicon dioxide particles

| | BET surface | Loss on drying | | Carbon |
|---|---|---|---|---|
| Aerosil ® type | m²/g | % by weight | pH | % by weight |
| R 972 | 110 ± 20 | <0.5 | 3.6-4.4 | 0.6-1.2 |
| R 974 | 170 ± 20 | <0.5 | 3.7-4.7 | 0.7-1.3 |
| R 104 | 150 ± 25 | — | >4.0 | 1.0-2.0 |
| R 106 | 250 ± 30 | — | >3.7 | 1.5-3.0 |
| R 202 | 100 ± 20 | <0.5 | 4.0-6.0 | 3.5-5.0 |
| R 805 | 150 ± 25 | <0.5 | 3.5-5.5 | 4.5-6.5 |
| R 812 | 260 ± 30 | <0.5 | 5.5-7.5 | 2.0-3.0 |
| R 816 | 190 ± 20 | <1.0 | 4.0-5.5 | 0.9-1.8 |
| R 7200 | 150 ± 25 | <1.5 | 4.0-6.0 | 4.5-6.5 |
| R 8200 | 160 ± 25 | <0.5 | >5.0 | 2.0-4.0 |
| R 9200 | 170 ± 20 | <1.5 | 3.0-5.0 | 0.7-1.3 |

a) following DIN 66131;
b) following DIN/ISO787/2, ASTM D 280, JIS K 5101/21;
c) following DIN/ISO787/9, ASTM D 1208, JIS K 5101/24; in 1:1 methanol:water
(proportions by volume)

Because of the hydroscopic isocyanate present in the processing aid according to the invention, the proportion of water in and on the hydrophobized metal oxide particles should be minimal. Generally, it should be less than 1% by weight, ideally less than 0.5% by weight, in each case based on the processing aid.

The tapped density of the powders used is not critical. Compacted or structurally modified types can additionally be used. The structural modification can be carried out by mechanical action and by optional remilling. The structural modification can, for example, be carried out with a bead mill or a continuously operating bead mill. The remilling can be carried out, for example, by means of an air jet mill, toothed disc mill or pin mill.

Compacted or structurally modified types show a exceptionally good workability. However, the generally cheaper uncompacted hydrophobized metal oxide particles may also be present in the processing aid according to the invention. These generally exhibit a tapped density of approximately 50 g/l.

b) Thermoplastic Polyurethane

All thermoplastic polyurethanes known to a person skilled in the art are suitable in principle for the processing aid according to the invention.

These are generally obtained by reaction of a diisocyanate with an OH-terminated polyester or an OH-terminated polyester with one or more compounds acting as chain extenders.

Polyesters generally used are linear polyesters with an average molecular weight (Mn) of 500 to 10 000, preferably of 700 to 5000 and particularly preferably of 800 to 4000.

The polyesters are obtained by esterification of one or more glycols with one or more dicarboxylic acids or the anhydrides thereof. In this connection, the dicarboxylic acids can be aliphatic, cycloaliphatic or aromatic. Suitable dicarboxylic acids are, for example, succinic acid, glutaric acid, adipic acid, pimelic acid, azelaic acid, sebacic acid, dodecanedicarboxylic acid, isophthalic acid, terephthalic acid or cyclohexanedicarboxylic acid.

Suitable glycols are, for example, ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol or dodecamethylene glycol.

OH-terminated polyethers are obtained by reaction of a diol or polyol, preferably an alkanediol or glycol, with an ether comprising alkylene oxides with 2 to 6 carbon atoms, typically ethylene oxide.

Suitable chain extenders are, for example, aliphatic glycols with 2 to 10 carbon atoms, such as ethylene glycol, diethylene glycol, propylene glycol, dipropylene glycol, 1,4-butanediol, 1,6-hexanediol, 1,3-butanediol, 1,5-pentanediol, 1,4-cyclohexanedimethanol or neopentyl glycol.

The third component of a thermoplastic polyurethane is an isocyanate. The isocyanate may be an aromatic, aliphatic, cycloaliphatic and/or araliphatic isocyanate, preferably a diisocyanate. Mention may be made, by way of example, of 2,2′-diphenylmethane diisocyanate, 2,4′-diphenylmethane diisocyanate, 4,4′-diphenylmethane diisocyanate (MDI), 1,5-naphthylene diisocyanate (NDI), 2,4-toluoylene diisocyanate, 2,6-Toluylene diisocyanate (TDI), 3,3′-dimethyldiphenyl diisocyanate, 1,2-diphenylethane diisocyanate, phenylene diisocyanate, trimethylene diisocyanate, tetramethylene diisocyanate, pentamethylene diisocyanate, hexamethylene diisocyanate, heptamethylene diisocyanate, octamethylene diisocyanate, 2-methylpentamethylene-1,5-diisocyanate, 2-ethyl-butylene-1,4-diisocyanate, pentamethylene-1,5-diisocyanate, butylene-1,4-diisocyanate, 1-isocyanato-3,3,5-trimethyl-5-isocyanatomethyl-cyclohexane (isophorone diisocyanate, IPDI), 1,4-bis(isocyanatomethyl)cyclohexane, 1,3-bis(isocyanatomethyl)cyclohexane (HXDI), 1,4-cyclohexane diisocyanate, 1-methyl-2,4-cyclohexane diisocyanate, 1-methyl-2,6-Dicyclohexylmethane diisocyanate, 4,4′-dicyclohexylmethane diisocyanate (H₁₂MDI), 2,4′-dicyclohexylmethane diisocyanate and/or 2,2′-dicyclohexylmethane-diisocyanate, whereas 2,2′-diphenylmethane diisocyanate, 2,4′-diphenylmethane diisocyanate, 4,4′-Diphenylmethane diisocyanate, 1,5-naphthylene diisocyanate, 2,4-toluoylene diisocyanate, 2,6-toluoylene diisocyanate, hexamethylene diisocyanate and/or IPDI are the preferred ones.

In addition to thermoplastic polyurethanes based on polyesters and polyethers, polyurethanes based on polycarbonates can also be present in the processing aid according to the invention. These can be prepared by reaction of diisocyanates with OH-terminated polycarbonates in the presence of a chain extender.

Commercially available thermoplastic polyurethanes are, for example, the Desmopan® types from Bayer, the Estane® types from Lubrizol or the Elastollan® types from BASF.

The proportion of thermoplastic polyurethane according to the invention is from 20 to 75% by weight, preferably from 30 to 60% by weight and particularly preferably from 40 to 50% by weight, in each case based on the processing aid.

c) Isocyanate

The processing aid according to the invention can comprise both aromatic and aliphatic isocyanates. Aliphatic or aromatic diisocyanates and aliphatic or aromatic triisocyanates are preferably involved. Mention may be made, by way of example, of 4,4′-methylenebis(phenyl isocyanate) (MDI), m-xylylene diisocyanate (XDI), phenylene 1,4-diisocyanate, naphthalene 1,5-diisocyanate, 3,3′-dimethoxydiphenylmethane 4,4′-diisocyanate and toluene diisocyanate (TDI), or aliphatic diisocyanates, such as isophorone diisocyanate (IPDI), 4,4′-dicyclohexylmethane diisocyanate (H₁₂MDI), hexamethylene diisocyanate, 1,4-cyclohexane diisocyanate (CHDI), decane 1,10-diisocyanate and dicyclohexylmethane 4,4′-diisocyanate. Preference may be given to 4,4′-methylenebis(phenyl isocyanate) (MDI) or uretonimine modified MDI. Commercially available products are for example Desmodur® CD, Bayer or Suprasec® 2020, Huntsman.

The proportion of isocyanate in the processing aid according to the invention is from 0.5 to 25% by weight, preferably from 5 to 22% by weight and most preferably from 10 to 20% by weight, in each case based on the processing aid.

d) Lubricant and Dispersant

The processing aid according to the invention furthermore comprises a lubricant and dispersant. This acts as friction-reducing internal and external lubricant and improves the flow properties during the preparation of the processing aid. In addition, it reduces or prevents adhesion to the surrounding material. Finally, it acts as dispersant for the hydrophobized metal oxide particles.

The lubricant and dispersant can preferably be chosen from the group consisting of an ester or amide of aliphatic carboxylic acids or carboxylic acid salts with in each case from 10 to 45 carbon atoms.

Mention may in particular be made of fatty acid derivatives, such as stearic acid ester, fatty acid amides, such as stearic acid amide, and fatty acid ester amides, such as stearic acid amide alkyl stearates. Typical examples may be: methylenebislauramide, methylenebismyristamide, methylenebispalmitamide, methylenebisstearamide, methylenebisbehenamide, methylenebisoleamide, ethylenebislauramide, ethylenebismyristamide, ethylenebispalmitamide, ethylenebisstearamide, ethylenebisbehenamide, ethylenebismontanamide and ethylenebisoleamide.

It has in particular been confirmed that fatty acid amides and hydrophobized pyrogenically prepared silicon dioxide particles result in an exceptional stabilizing of the melt in the preparation of the processing aid and in the use of the processing aid in the processing of thermoplastic polyurethanes.

It is furthermore possible to use compounds bearing a polyester polysiloxane block copolymer, preferably a polyester-polysiloxane-polyester triblock copolymer. this comprises for example polycaprolactone-polydimethysiloxane-polycaprolactone triblock copolymers. A commercially available member of this group is TEGOMER® H—Si 6440 P, Evonik Goldschmidt.

The proportion of lubricant and dispersant in the processing aid according to the invention is from 0.5 to 15% by weight, preferably from 2 to 12.5% by weight, most preferably from 5 to 10% by weight, in each case based on the processing aid.

The processing aid according to the invention is a universal processing aid for the processing of thermoplastic polyurethanes, i.e. hydrophobized metal oxide particles, thermoplastic polyurethane, isocyanate and lubricant and dispersant can be combined in any way.

In a preferred embodiment of the invention, the processing aid comprises

a) from 20 to 40% by weight of hydrophobized pyrogenic silicon dioxide particles,

b) from 30 to 60% by weight of thermoplastic polyurethane,

c) from 5 to 20% by weight of isocyanate,

d) from 5 to 10% by weight of lubricant and dispersant, in each case based on the processing aid, these constituents representing at least 90%, preferably at least 95% by weight of the processing aid or the processing aid consisting exclusively of these constituents.

In this connection, any materials additionally present in the commercially available thermoplastic polymers are to be regarded as part of the thermoplastic polymer.

An additional subject-matter of the invention is a process for the preparation of the processing aid, in which a mixture of a melt of a thermoplastic polyurethane and hydrophobized metal oxide particles, isocyanates and lubricant and dispersant is metered into an extruder or an injection-moulding device. In this connection, the constituents of the processing aid according to the invention can be metered in together or separately.

An extruder may preferably be used. Advantageously, the metering is carried out in such a way that the thermoplastic polyurethane and the hydrophobized metal oxide particles are first mixed, the mixture is heated to temperatures at which the thermoplastic polyurethane is present in the molten form and the isocyanate and the lubricant and dispersant are metered into this mixture in the extruder at a later point in time.

Extruders known to a person skilled in the art may be used. The temperature of the melt is usually from 150° C. to 240° C., preferably from 180° C. to 230° C. The processing aid obtained is subsequently cooled and granulated or cooled on granulating.

The thermoplastic polyurethane can be used in the process according to the invention in the form of granules or pellets, preferably as granule. The hydrophobized metal oxide particles can be used as powder or granule.

The use of the processing aid according to the invention in the processing of thermoplastic polyurethanes results in an increased stability of the melt, in an increased rate of crystallization, in a reduction in friction and in an increase in the molecular weight. Accordingly, an additional subject-matter of the invention is the use of the processing aid in the processing of thermoplastic polyurethanes to give films, hoses, cable sheathings, injection mouldings or fibres.

The processing aid according to the invention is suitable in particular for the preparation of self-supporting blown films. The term “self-supporting” is understood as meaning that no supporting body is used in the preparation of the film.

Accordingly, an additional subject-matter of the invention is a process for the preparation of self-supporting films, in which a mixture of a thermoplastic polyurethane and from 0.5 to 35% by weight, preferably from 1 to 20% by weight and most preferably from 5 to 15% by weight, in each case based on the total amount of thermoplastic polyurethane, of the processing aid according to the invention is metered into an extruder and the mixture is melted and extruded via a film blowing die to give a film.

Having generally described this invention, a further understanding can be obtained by reference to certain specific examples which are provided herein for purposes of illustration only, and are not intended to be limiting unless otherwise specified.

### EXAMPLES

### Preparation of processing aids according to the invention

Starting Materials
AEROSIL® R974, Evonik Degussa.
Estane® 58271: an 85A aromatic polyester based TPU, Lubrizol.
Estane® 58300: an 82A aromatic polyether based TPU, Lubrizol.
Desmopan® W85085A: aliphatic TPU based on polyesteretherpolyols, Fa. Bayer MaterialScience AG.
Desmodur® CD: modified Diphenyl-methane-4,4′-diisocyanate, Bayer MaterialScience AG.
Vestanat® 1890-100: cycloaliphatic polyisocyanate based on IPDI, Evonik Degussa.
Suprasec®: MDI, Huntsman.
Erucamid: CRODA ER.
Ethylenbisoleamid: CRODA EBO.
Tegomer® H—SI 6440P: polyester-polysiloxan-polyester-block copolymer, Evonik Goldschmidt.
Acrawax® E: ethylene bisstearamid, Lonza.

### Example 1

A mixture of 50 parts by weight of Estane® 58271, Lubrizol, and 30 parts by weight of Aerosil® R974, Evonik Degussa, were metered into a twin-screw extruder operated at a screw speed of 600 rev/min and at a temperature of 160° C. to 200° C. Subsequently 20 parts by weight of MDI (Suprasec®; Huntsman) and 10 parts by weight of erucamide/ethylenebisoleamide are metered in. The mixture was subsequently granulated.

### Examples 2 to 4

were carried out analogously. Starting materials and amounts used are represented in Table 2.

TABLE 2
Processing aid-Starting materials and amounts used

| | Example | | | |
|---|---|---|---|---|
| | 1 | 2 | 3 | 4 |
| TPU | Estane ® | Estane ® | Estane ® | Desmopan ® |
| | 58271 | 58271 | 58300 | W85085A |
| % by weight | 50 | 40 | 40 | 30 |
| Hydro- | AEROSIL ® | AEROSIL ® | AEROSIL ® | AEROSIL ® |
| phobized | R974 | R974 | R974 | R974 |
| metal oxide | | | | |
| particles | | | | |
| % by weight | 30 | 30 | 30 | 40 |
| Isocyanate | MDI | MDI | Desmodur ® | Vestanat ® |
| | | | CD | 1890-100 |
| % by weight | 10 | 20 | 20 | 28 |
| Lubricant | Erucamid/ | Erucamid/ | EBO/ | EBO/ |
| and | EBO | EBO | Tegomer ® | Acrawax E |
| dispersant | | | H-Si6440P | |
| % by weight | 10 | 10 | 10 | 2 |

B) Preparation of Self-Supporting Blown Films

### Example 5

The thermoplastic polyurethane Estane® 58447, Lubrizol, and 10 parts by weight, based on the thermoplastic polyurethane, of the processing aid according to the invention from Example 1 were melted in an extruder and extruded through a film blowing die to give a tubular film.

### Example 6

Analogously to Example 5 but using Desmopan® 786E, Bayer, instead of Estane® 58447.

### Example 7

Analogously to Example 5 but using Desmopan® 3660D, Bayer, instead of Estane® 58447.

It is known to a person skilled in the art that the thermoplastic polyurethanes used in Examples 5 to 7 can be processed only with difficulty or cannot by processed at all to give self-supporting films. With the help of the processing aid according to the invention from Example 1, this is successful in all three examples.

In the presence of the processing aid according to the invention, an approximately 15° C. higher processing temperature can moreover be chosen, whereby die drooling (the dropping of melt down onto the nozzle) and the presence of unmelted thermoplastic polymer can be reduced or avoided. The presence of the processing aid according to the invention results in an increase in the tensile strength together with a reduction in the elongation.

European patent application EP 08166704.0 filed Oct. 15, 2008, and U.S. provisional application 61/106,737, filed Oct. 20, 2008, are incorporated herein by reference.

Numerous modifications and variations on the present invention are possible in light of the above teachings. It is therefore to be understood that within the scope of the appended claims, the invention may be practiced otherwise than as specifically described herein.

1-19. (canceled)

20. A process for obtaining a thermoplastic polyurethane article, comprising:
processing a thermoplastic polyurethane in the presence of a processing aid to obtain a thermoplastic polyurethane, said processing aid comprises
a) 10-50% by weight of hydrophobized, at least partially aggregated, metal oxide particles selected from the group consisting of aluminium oxide, silicon dioxide and mixtures thereof,
b) 20-75% by weight of at least one thermoplastic polyurethane,
c) 0.5-25% by weight of at least one isocyanate,
d) 0.5-15% by weight of at least one compound which act as lubricant and dispersant, the sum of the constituents a) to d) is at least 90% by weight of the processing aid, based on a total weight of said processing aid.

21. The process according to claim 20, wherein the hydrophobized metal oxide particles have, on a surface thereof, a group selected from the group consisting of 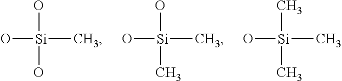
and a mixture thereof.

22. The process according to claim 20, wherein the hydrophobized metal oxide particles are pyrogenic metal oxide particles.

23. The process according to claim 22, wherein a density of OH groups of the hydrophobized metal oxide particles is equal to or less than 1 OH/nm².

24. The process according to claim 22, wherein the hydrophobized metal oxide particles comprise hydrophobized pyrogenic silicon dioxide particles.

25. The process according to claim 20, wherein the lubricant and dispersant is selected from the group consisting of an ester of an aliphatic carboxylic acid, an amide of an aliphatic carboxylic acid, a carboxylic acid salt and mixtures thereof, with in each case from 10 to 45 carbon atoms.

26. The process according to claim 20, wherein said hydrophobized, at least partially aggregated, metal oxide particles are aluminium oxide particles.

27. The process according to claim 20, wherein said hydrophobized, at least partially aggregated, metal oxide particles are aluminium oxide particles and silicon dioxide particles present as a mixture.

28. The process according to claim 20, wherein the sum of the constituents a) to d) is at least 95% by weight of the processing aid, based on a total weight of said processing aid.

29. The process according to claim 20, wherein said processing aid comprises from 20-40% by weight of hydrophobized, at least partially aggregated, metal oxide particles.

30. The process according to claim 20, wherein said processing aid comprises from 30-60% by weight of the at least one thermoplastic polyurethane.

31. The process according to claim 20, wherein said processing aid comprises from 40-50% by weight of the at least one thermoplastic polyurethane.

32. The process according to claim 20, wherein said processing aid comprises from 5-22% by weight of the at least one isocyanate.

33. The process according to claim 20, wherein said processing aid comprises from 10-20% by weight of the at least one isocyanate.

34. The process according to claim 20, wherein said processing aid comprises from 2-12.5% by weight of at least one compound which act as lubricant and dispersant.

35. The process according to claim 20, wherein said processing aid comprises from 5-10% by weight of at least one compound which act as lubricant and dispersant.

36. The process according to claim 20, wherein said processing comprises mixing a thermoplastic polyurethane and said processing aid at a temperature of from 150 to 240° C. to form a melt, extruding the melt, and cooling the melt.

37. The process according to claim 20, wherein said processing aid comprises
a) from 20 to 40% by weight of hydrophobized pyrogenic silicon dioxide particles,
b) from 30 to 60% by weight of the thermoplastic polyurethane,
c) from 5 to 20% by weight of the isocyanate,
d) from 5 to 10% by weight of the lubricant and dispersant, the sum of the constituents a) to d) is at least 90% by weight of the processing aid, based on a total weight of said processing aid.
